(19) United States
(12) Patent Application Publication
(10) Pub. No.: US 2008/0153003 A1
(43) Pub. Date: Jun. 26, 2008

(54) Zinc Alloy Powder For Use In An Alkaline Battery

(75) Inventor: Francisco Javier Alday Lesaga, Alava (ES)

Correspondence Address: BERENBAUM, WEINSHIENK & EASON, P.C, 370 17TH STREET, SUITE 4800, DENVER, CO, 80202, US

(73) Assignee: CELAYA, EMPARANZA Y GALDOS, S.A. (CEGASA), Vitoria (Alava) (ES)

(21) Appl. No.: 11/816,820

(22) PCT Filed: Feb. 20, 2006
(86) PCT No.: PCT/EP2006/060116

§ 371 Date: Nov. 8, 2007

(30) Foreign Application Priority Data
Feb. 21, 2005 (ES) 200500383

(51) Int. Cl. H01M 4/42; C22C 18/00

(52) U.S. Cl. 429/226; 420/519; 429/229

(57) ABSTRACT

Zinc alloy for use in an alkaline battery, the alloy including aluminium, bismuth, indium, magnesium, strontium and optionally lead, besides the unavoidable impurities in the aforementioned metals. The alloy can be made by adding pre-alloys of some of the alloying elements or of zinc. The alloy proves useful in reducing the hydrogen gas evolution of the battery.

The present invention relates to an alloy for use in an alkaline battery and to a method for producing said alloy, the method comprising, among other steps, preparing a zinc melt. The invention also relates to a zinc alloy powder for use in an alkaline battery and to an alkaline battery which is provided with said zinc alloy powder.

### BACKGROUND ART

Zinc in the electrolyte of alkaline batteries forms unwanted hydrogen gas according to the reaction:

Zn+2H₂O+2OH⁻→Zn(OH)₄²⁻+H₂

This reaction is called “hydrogen gas evolution” or just gas evolution.

Since alkaline batteries are preferably closed systems, the gas will produce the swelling of the anode and thus will change its characteristics, like e.g. its internal resistance. Therefore, it is desirable that the gas evolution proceeds at the slowest possible speed.

The kinetics of this reaction depends on many parameters, such as the relative surface area of the zinc powder particles that form the anode and the purity of the zinc. It is known that alloying or micro-alloying the zinc with certain elements may slow down the gas evolution; the term “micro-alloying” shall be understood as alloying with concentrations on up to a few hundred ppm in weight. The term “ppm” means “parts per million”, and in this specification it shall be understood as parts per million in mass relative to the mass of zinc in the alloy.

According to the literature, the addition of small quantities of many elements to anode zinc alloys has been tested and some elements have proved useful in reducing gas evolution if alloyed in certain concentrations; among these can be cited, for example, Pb, Tl, Sn, Co, Ca, Sr, Mg, Ni, Ta, Te, In, Ga, Bi, Al, Be, Ba, Mo, Cd, K or Ag.

Patent document JP62123656 (Mitsui) discloses an alkaline battery which uses as the anode material a zinc alloy that contains 0.005-0.5 weight percentage (wt %) of lead, 0.001-0.5 wt % of indium and 0.005-0.5 wt % of aluminium, an amount of 0.01-0.5 wt % of more than one element selected from thallium, tin and gallium, and an amount of 0.0001-0.5 wt % of more than one element selected from magnesium, calcium, strontium, nickel, cobalt, tantalum and tellurium.

Patent document EP0686207 (Union Miniere) discloses an aluminium-bearing zinc powder for alkaline batteries, the zinc powder consisting of 0.0016-0.0095 wt % of aluminium, and of one of 0.001-2.0 wt % of bismuth, 0.005-2.0 wt % of indium and 0.003-2.0 wt % of lead.

Patent document WO9607765 (Union Miniere) discloses a zinc powder consisting of 0.0005-1 wt % of aluminium, 0.001-2.0% wt % of at least one of bismuth, indium and gallium, one or several elements of the group of elements consisting of magnesium, strontium, barium and REM (rare earth metals) such that the ratio between the number of moles of Al and the total number of moles of these elements amounts at most to 2, and such that the sum of the concentrations of aluminium and of these elements amounts at most to 2.0 wt %.

Patent document JP11265715 (Dowa) discloses a zinc alloy powder that contains 0.0001-0.5 wt % of at least one metal selected from Al, K, In, TI, Mg, Ca, Sr, Sn, Pb, Bi, Cd, Ag and Te. The zinc alloy powder is manufactured by atomizing it in the air and then is heat-treated in inert gas or reducing gas.

It is known in the art that lead is beneficial in reducing gas evolution in alkaline batteries which employ zinc alloys as the anode material, but because of its health hazards lead can only be used in minute quantities and, according to the teachings of the art, added in such small quantities it has little effect. Anyway, lead is present in zinc as an unavoidable impurity, in concentrations that some specifications allow to be of up to 30 ppm.

### SUMMARY OF THE INVENTION

The alloys considered in the present invention are zinc alloys which contain as major alloying elements Al, Bi and In (so called ABI zinc alloys).

It is an object of the present invention to provide a zinc alloy powder for alkaline batteries which, while containing just minute quantities of lead, may offer a good behaviour in terms of hydrogen gas evolution.

According to one aspect of the invention, it is provided an alloy consisting essentially of zinc and the alloying elements aluminium, bismuth, indium, magnesium, strontium and optionally lead, the rest being unavoidable impurities in the aforementioned metals. The applicant has found that adding minute quantities of magnesium and strontium and possibly lead to an ABI Zn alloy the gas evolution of the battery is reduced.

Lead can be added to the ABI Zn alloy as an alloying element in a quantity that depends on the concentration of lead already present as an impurity in the starting materials. In some cases there may be no need of adding any additional lead.

In an embodiment the concentration of aluminium in the alloy is between 20 ppm and 500 ppm.

In an embodiment the concentration of bismuth in the alloy is between 20 ppm and 2000 ppm.

In an embodiment the concentration of indium in the alloy is between 20 ppm and 2000 ppm.

In an embodiment the concentration of magnesium in the alloy is between 1 ppm and 100 ppm.

In an embodiment the concentration of strontium in the alloy is between 1 ppm and 100 ppm.

In an embodiment the concentration of lead in the alloy is less than 100 ppm.

Advantageously, the concentration of aluminium is between 20 ppm and 500 ppm, the concentration of bismuth is between 20 ppm and 2000 ppm, the concentration of indium is between 20 ppm and 2000 ppm, the concentration of magnesium is between 1 ppm and 100 ppm, the concentration of strontium is between 1 ppm and 100 ppm, and the concentration of lead is less than 100 ppm.

Preferably, the individual added content of lead, magnesium or strontium is less than or equal to the content of aluminium.

According to another aspect of the invention, it is provided a method for producing a zinc alloy which comprises adding to the zinc melt as alloying elements aluminium, bismuth, indium, magnesium, strontium and optionally lead.

In an embodiment the method comprises adding to the melt a pre-alloy of In—Bi.

In an embodiment the method comprises adding to the melt a pre-alloy of Al—Sr.

In an embodiment the method comprises adding to the melt a pre-alloy of Al—Mg.

Advantageously, at least two of the alloying elements are added to the melt in the form of a mixture whose density is close to the density of the zinc melt.

In an embodiment, at least one of the alloying elements is added to the melt as a pre-alloy of zinc.

Preferably, the concentrations of the alloying elements added to the zinc melt are as defined above in this section.

According to yet another aspect of the invention, it is provided a zinc alloy powder such that the zinc alloy is as defined above in this section.

According to yet another aspect of the invention, it is provided an alkaline battery provided with a zinc alloy powder as defined in the previous paragraph.

Advantageously, said zinc alloy powder is used as a material for the anode of the battery.

### BRIEF DESCRIPTION OF THE DRAWINGS

Several particular embodiments of the present invention will be described in the following, only by way of non-limiting example, with reference to the appended drawings, in which:

FIG. 1 is a diagram showing some experimental results.

### DESCRIPTION OF PARTICULAR EMBODIMENTS

In order to reduce gas evolution in a Zn-based alkaline battery, the anode of such a battery according to the invention comprises a powder made from an alloy which consists essentially of zinc and the alloying elements aluminium, bismuth, indium, magnesium, strontium and optionally lead, plus the unavoidable impurities. Additional lead, besides the lead already present as an impurity, may or may not be added to the alloy.

This is based on the unexpected finding that a combination of even minute quantities of lead, magnesium and strontium, well below the amounts known in the art to have an effect, have a beneficial effect on the properties of ABI zinc alloy powders in alkaline batteries.

Powders according to the invention can be made by melting zinc and alloying it with Al, Bi, In, Mg, Sr and possibly Pb, meaning that all these elements are added individually. The melt is atomized with a jet of pressurized air or other suitable atomization processes, like centrifugal atomization.

In some embodiments, these powders can be made from a melt of zinc to which said elements are added in suitable pre-alloys, like In—Bi, Al—Sr or Al—Mg.

In other embodiments, said alloying elements are added by making mixtures which are heavy enough to prevent the alloying components from floating on the zinc melt, in such a way that the different densities of said elements are used to make mixtures which have a density close to the density of the zinc melt.

In yet other embodiments, pre-alloys are made of Zn and thus added to the melt, for example by adding to the zinc melt tablets of Zn—Al—Sr and Zn—Mg, and separately of In, Bi and Pb.

The concentrations of the alloying elements in the zinc alloy are:

Al: between 20 ppm and 500 ppm
Bi: between 20 ppm and 2000 ppm
In: between 20 ppm and 2000 ppm
Mg: between 1 ppm and 100 ppm
Sr: between 1 ppm and 100 ppm.
Pb: less than 100 ppm (including the lead already present)

These concentrations are ppm in mass relative to the mass of Zn.

The added content of each of the elements Mg, Pb, and Sr shall in general be less than or equal to the content of Al, since the idea is to use aluminiferous alloys where Al, Bi and In are the predominant alloying elements. However, the total concentration of Pb in the alloy can be higher than the Al concentration, because lead is normally present in zinc as an unavoidable impurity and adding up the unavoidable content and the added amount of Pb, the Pb total concentration may exceed the Al concentration.

The present invention will be further described by way of examples, which are meant to illustrate the invention without limiting it.

### Example 1

It requires special procedures to alloy zinc with elements like Al, Mg and Sr, since these elements have a lower density than the zinc melt and their melting points are above the temperature of the zinc melt to be atomized. Care has to be taken that, if these elements are added as bulk material, the pieces are wetted by the melt and do not oxidize but instead dissolve.

In a continuous melting and atomizing process, amounts of these elements have to be added continuously or quasi continuously to the melt. In a typical atomization process, the zinc melt is atomized at a rate of 500 to 1000 kg per hour.

In a melting furnace with a capacity of 1000 kg, SHG (Special High Grade) zinc, which contained 15 ppm of Pb, was melted. To the melt was added as bulk material 100 g of Al, 200 g of Bi, 200 g of In, 3 g of Sr and 10 g of Mg.

Theoretically, the resulting alloy would be: Zn, 100 ppm of Al, 200 ppm of Bi, 200 ppm of In, 3 ppm of Sr and 10 ppm of Mg.

The melt was transferred to a tundish via some launders. From the tundish a melt stream was made to flow past air nozzles to be atomized.

The analysis of the powder was found to be different from the intended analysis:

| | | Intended | Analyzed |
|---|---|---|---|
| | | amount | content |
| Element | Symbol | [ppm] | [ppm] |
| Aluminium | Al | 100 | <30 |
| Bismuth | Bi | 200 | 200 +− 20 |
| Indium | In | 200 | 200 +− 20 |
| Magnesium | Mg | 10 | <1 |
| Strontium | Sr | 3 | <1 |

The difference can be explained by losses due to oxidation and by the zinc foam skimmed from the surface in the tundish.

### Example 2

A melting furnace with a capacity of 1000 kg Zn was used; the furnace was able to melt 1000 kg per hour. It was filled with SHG Zn containing 15 ppm of Pb. From this furnace a tundish for atomization was filled with zinc melt in intervals of 30 min, each time transferring 250 kg of Zn to the tundish. Thus for melting 250 kg of Zn in the furnace 30 min were available. This was done by inserting a length of a zinc ingot corresponding to 250 kg into the melt.

While melting this amount of zinc, 50 g of Bi pellets and 50 g of In pellets were added to the melt. A rod of an Al-3% Sr alloy was pushed into the melt, so that a portion corresponding to 33.5 g was immersed. A Zn can for saline battery production was filled with 3 g of Mg pellets and 2.5 g of Pb cut from wire. The can was compressed and closed and added to the melt.

The analysis of the atomized powder was found to be on average:

| | | | Analyzed |
|---|---|---|---|
| | | Intended amount | content |
| Element | Symbol | [ppm] | [ppm] |
| Aluminium | Al | 100 | 100 +− 10 |
| Bismuth | Bi | 200 | 200 +− 20 |
| Indium | In | 200 | 200 +− 20 |
| Magnesium | Mg | 10 | 10 +− 2 |
| Lead | Pb | 25 | 25 +− 3 |
| Strontium | Sr | 3 | 3 +− 0.3 |

### Example 3

Tablets of a pre-alloy containing Zn and the elements Al, Bi, In, Mg, Pb and Sr were made.

Each tablet had a weight of 300 g and contained besides Zn the following amounts:

| Element | Symbol | g |
|---|---|---|
| Aluminium | Al | 16 |
| Bismuth | Bi | 25 |
| Indium | In | 25 |
| Magnesium | Mg | 2 |
| Lead | Pb | 1.2 |
| Strontium | Sr | 0.6 |

During the melting process, as described in example 1, for every melting step of 250 kg of Zn two tablets were added to the melt.

The analysis of the powder was found to be on average:

| | | Analyzed |
|---|---|---|
| | | content |
| Element | Symbol | [ppm] |
| Aluminium | Al | 100 +− 10 |
| Bismuth | Bi | 200 +− 20 |
| Indium | In | 200 +− 20 |
| Magnesium | Mg | 10 +− 2 |
| Lead | Pb | 25 +− 3 |
| Strontium | Sr | 3 +− 0.3 |

### Example 4

Another way for alloying the zinc is preparing physical mixtures of the elements and compressing them in a zinc can. As shown in the following table, a suitable mixture may have an overall density which is close to the density of the zinc melt. Such Zn cans with mixtures can be added to the melt. Since they are wetted by the melt and can submerse, the ingredients are well alloyed to the zinc melt.

The following table shows the melting points and the density of the interesting elements.

| | | | melting |
|---|---|---|---|
| | | density | point |
| Element | Symbol | [g/ml] | [° C.] |
| Aluminium | Al | 2.7 | 660 |
| Bismuth | Bi | 9.8 | 271 |
| Indium | In | 7.3 | 156 |
| Magnesium | Mg | 1.7 | 650 |
| Lead | Pb | 11.3 | 327 |
| Strontium | Sr | 2.6 | 777 |

For the alloy composition as given in the following table there results a density of 6.9 g/ml at 20° C.

| Alloy | | | Resultant |
|---|---|---|---|
| composition | | | Volume |
| [ppm] | Element | Symbol | [ml] |
| 50 | Aluminium | Al | 18.5 |
| 300 | Bismuth | Bi | 30.7 |
| 300 | Indium | In | 41.1 |
| 8 | Magnesium | Mg | 4.6 |
| 10 | Lead | Pb | 0.9 |
| 3 | Strontium | Sr | 1.1 |

### Example 5

One way of characterizing the usefulness of a certain zinc powder for alkaline batteries is to make the so called “PD-Gas Test.” (post-Partial-Discharge gas evolution test). This test is made by preparing cells, e.g. LR6 or LR14 cells, with the zinc powder to be scrutinized and subjecting the cells to a partial discharge, e.g. for LR6 cells discharging them through a load of 2.2 Ohm for 0 min, for 15 min, for 60 min and for 120 min respectively. Then the cells are kept in a laboratory furnace at a temperature of 70° C. for 7 days. Thereafter the cells are opened and the escaping gas from each cell is captured and its volume is recorded.

For a number of Zn powder samples this test was carried out with LR6 cells. The analysis of the samples is given in the following table.

| | Al | Bi | In | Mg | Pb | Sr |
|---|---|---|---|---|---|---|
| | [ppm] | [ppm] | [ppm] | [ppm] | [ppm] | [ppm] |
| Average | 59 | 225 | 211 | 0 | 23 | 1.8 |
| Standard | 15 | 19 | 20 | 0 | 5 | 0.4 |
| Deviation | | | | | | |

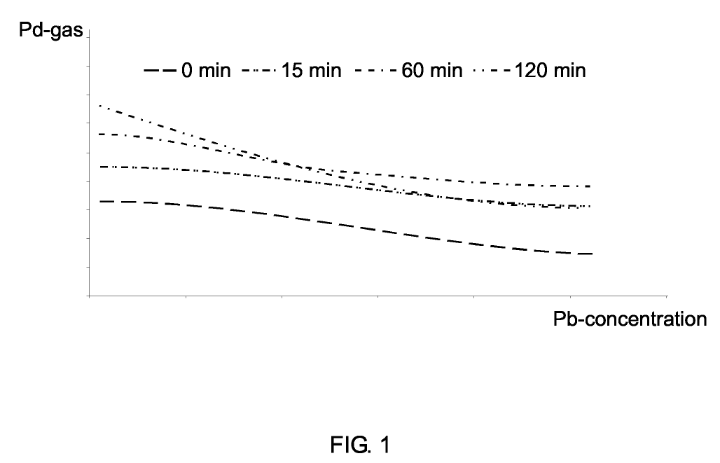

The results of the PD-gas evolution are represented in FIG. 1. The Pb content is represented in abscises and the PD gas volumes are represented in ordinates. In order to get the data into one diagram there is plotted one curve for a 0 minute discharge, one curve for a 15 minute discharge, one curve for a 60 minute discharge and one curve for a 120 minute discharge.

The diagram shows that with increasing Pb content there is a clear tendency of the PD gas evolution to decrease. In other words, the example shows that even small additions of Pb can reduce the PD gas evolution of aluminiferous zinc powders. This is an advantage to be weighted against the disadvantage of not corresponding to the tendency of having “no lead-added” batteries.

### Example 6

Another way to characterize zinc powder for alkaline cells is the determination of gas evolution outside cells. One possible method is to investigate the gas given off by 25 g of zinc powder in 130 ml of electrolyte per day at a reaction temperature of 70° C. This method was used to determine the “FdP”=“Out-of-Cell” gas evolution of different alloy powders.

The alloying composition (in ppm) and the out-of-cell gas, given in ml per 25 g per day at 70° C., are listed in the following tables, which show a reduction in the gas evolution with increasing (up to a point) quantities of Pb, Mg and Sr.

| Type | Sample | Al | Bi | In | Pb | Mg | Sr |
|---|---|---|---|---|---|---|---|
| ABI | 12-9-1 | 82 | 217 | 252 | 16 | 0.88 | 0.01 |
| | (12/9/05) | | | | | | |
| ABI | 12-9-2 | 78 | 217 | 253 | 16 | 0.90 | 0.02 |
| | (12/9/05) | | | | | | |
| ABI | 12-9-3 | 78 | 219 | 254 | 16 | 1.12 | 0.01 |
| | (12/9/05) | | | | | | |
| ABI + Pb + Sr | P/1 | 106 | 232 | 213 | 21 | 0 | 1.7 |
| | (29/7/05) | | | | | | |
| ABI + Pb + Sr | P/3 | 100 | 229 | 209 | 21 | 0 | 1.4 |
| | (29/7/05) | | | | | | |
| ABI + Pb + Sr | P/4 | 96 | 225 | 210 | 21 | 0 | 19.3 |
| | (29/7/05) | | | | | | |
| ABI + Mg + Sr + | P/2 | 104 | 337 | 208 | 20 | 15 | 1.6 |
| Pb | (29/7/05) | | | | | | |

| | | FdP 1 day | FdP 2 days |
|---|---|---|---|
| Type | Sample | [ml/25 g] | [ml/25 g] |
| ABI | 12-9-1 | 0.57 | 1.15 |
| | (12/9/05) | | |
| ABI | 12-9-2 | 0.52 | 1.07 |
| | (12/9/05) | | |
| ABI | 12-9-3 | 0.66 | 1.21 |
| | (12/9/05) | | |
| ABI + Pb + Sr | P/1 | 0.41 | 0.72 |
| | (29/7/05) | | |
| ABI + Pb + Sr | P/3 | 0.45 | 0.84 |
| | (29/7/05) | | |
| ABI + Pb + Sr | P/4 | 0.35 | 0.66 |
| | (29/7/05) | | |
| ABI + Mg + Sr + | P/2 | 0.22 | 0.47 |
| Pb | (29/7/05) | | |

### Example 7

The following table lists a number of possible concentrations (in ppm) of the alloying elements according to the invention. It should be noted that the Pb values given are the sum of the unavoidable impurities and the added alloying content.

| Al | Bi | In | Pb | Mg | Sr |
|---|---|---|---|---|---|
| 500 | 2000 | 2000 | 20 | 16 | 15 |
| 25 | 200 | 200 | 25 | 16 | 1 |
| 500 | 50 | 50 | 20 | 16 | 15 |
| 25 | 50 | 50 | 20 | 16 | 2 |
| 500 | 500 | 50 | 20 | 16 | 2 |
| 25 | 100 | 50 | 20 | 16 | 2 |
| 500 | 200 | 500 | 20 | 16 | 15 |
| 25 | 200 | 50 | 20 | 16 | 2 |
| 500 | 50 | 50 | 45 | 16 | 15 |
| 25 | 50 | 50 | 50 | 16 | 2 |
| 500 | 500 | 50 | 45 | 16 | 15 |
| 25 | 100 | 50 | 55 | 16 | 2 |
| 500 | 200 | 500 | 43 | 16 | 15 |
| 25 | 200 | 50 | 20 | 16 | 2 |
| 500 | 50 | 50 | 20 | 50 | 15 |
| 25 | 50 | 50 | 20 | 50 | 2 |
| 500 | 500 | 50 | 20 | 45 | 15 |
| 25 | 100 | 50 | 20 | 32 | 2 |
| 500 | 200 | 500 | 20 | 45 | 15 |
| 25 | 200 | 50 | 20 | 45 | 2 |
| 500 | 50 | 50 | 45 | 30 | 15 |
| 25 | 50 | 50 | 50 | 10 | 2 |
| 500 | 500 | 50 | 45 | 30 | 15 |
| 25 | 100 | 50 | 55 | 10 | 2 |
| 500 | 200 | 500 | 43 | 30 | 2 |
| 25 | 200 | 50 | 20 | 10 | 2 |
| 500 | 200 | 500 | 20 | 45 | 50 |
| 25 | 200 | 50 | 20 | 45 | 10 |
| 500 | 50 | 50 | 45 | 30 | 50 |
| 25 | 50 | 50 | 50 | 10 | 10 |
| 500 | 500 | 50 | 45 | 30 | 50 |
| 25 | 100 | 50 | 55 | 10 | 10 |
| 500 | 200 | 500 | 43 | 30 | 15 |
| 25 | 200 | 50 | 20 | 10 | 2 |

### CONCLUSION

In the preceding examples it can be seen that the rate of hydrogen gas evolution is reduced by adding minute quantities Sr, Mg and possibly Pb to an ABI Zn alloy.

Although only particular embodiments of the invention have been shown and described in the present specification, the skilled man will be able to introduce modifications and substitute any technical features thereof with others that are technically equivalent, depending on the particular requirements of each case, without departing from the scope of protection defined by the appended claims.

1. Zinc alloy for Use in an alkaline battery, the alloy comprising aluminum, bismuth, indium, magnesium, and strontium as alloying elements.

2. Zinc alloy according to claim 1, wherein the concentration of aluminum in the alloy is between about 20 ppm and about 500 ppm.

3. Zinc alloy according to claim 1, wherein the concentration of bismuth in the alloy is between about 20 ppm and about 2000 ppm.

4. Zinc alloy according to claim 1, wherein the concentration of indium in the alloy is between about 20 ppm and about 2000 ppm.

5. Zinc alloy according to claim 1, wherein the concentration of magnesium in the alloy is between about 1 ppm and about 100 ppm.

6. Zinc alloy according to claim 1, wherein the concentration of strontium in the alloy is between about 1 ppm and about 100 ppm.

7. Zinc alloy according to claim 1, wherein the concentration of lead in the alloy is less than about 100 ppm.

8. Zinc alloy according to claim 1 wherein the concentration of aluminium is between about 20 ppm and about 500 ppm, the concentration of bismuth is between about 20 ppm and about 2000 ppm, the concentration of indium is between about 20 ppm and about 2000 ppm, the concentration of magnesium is between about 1 ppm and about 100 ppm, the concentration of strontium is between about 1 ppm and about 100 ppm, and the concentration of lead is less than about 100 ppm.

9. Zinc alloy according to claim 1, wherein the content of lead is less than or equal to the content of aluminum.

10. Zinc alloy according to claim 1, wherein the added content of magnesium is less than or equal to the content of aluminum.

11. Zinc alloy according to claim 1, wherein the added content of strontium is less than or equal to the content of aluminum.

12. Method for producing a zinc alloy for use in an alkaline battery, which comprises preparing a zinc melt and adding to said melt as alloying elements aluminum, bismuth, indium, magnesium, strontium and optionally lead.

13. Method according to claim 12, which comprises additionally adding to the melt a pre-alloy of In—Bi.

14. Method according to claim 12, which comprises additionally adding to the melt a pre-alloy of Al—Sr.

15. Method according to claim 12, which comprises additionally adding to the melt a pre-alloy of Al—Mg.

16. Method according to claim 12, wherein at least two of the alloying elements are added to the melt in the form of a mixture of a density close to the density of the zinc melt.

17. Method according to claim 12, wherein at least one of the alloying elements is added to the melt as a pre-alloy of zinc.

18-21. (canceled)

22. Method according to claim 12, which comprises adding lead to the melt.

23. Method according to claim 12, which comprises adding lead to the melt for reaching a lead concentration of less than about 100 ppm.

24. Method according to claim 12, wherein the zinc alloy has a concentration of aluminium in the range between about 20 ppm and about 500 ppm, a concentration of bismuth in the range between about 20 ppm and about 2000 ppm, a concentration of indium in the range between about 20 ppm and about 2000 ppm, a concentration of magnesium in the range between about 1 ppm and about 100 ppm and a concentration of strontium in the range between about 1 ppm and about 100 ppm.

25. Alkaline battery which comprises a zinc alloy, wherein said zinc alloy comprises aluminum, bismuth, indium, magnesium and strontium as alloying elements.

26. Alkaline battery according to claim 25 wherein said zinc alloy comprises lead.

27. Alkaline battery according to claim 25, wherein the zinc alloy has a concentration of aluminium in the range between about 20 ppm and about 500 ppm, a concentration of bismuth in the range between about 20 ppm and about 2000 ppm, a concentration of indium in the range between about 20 ppm and about 2000 ppm, a concentration of magnesium in the range between about 1 ppm and about 100 ppm, a concentration of strontium in the range between about 1 ppm and about 100 ppm, and a concentration of lead lower than about 100 ppm.

28. Alkaline battery according to claim 25, wherein said zinc alloy is used as a material for the anode of the battery.
